(19) United States
(12) Patent Application Publication
(10) Pub. No.: US 2016/0130435 A1
(43) Pub. Date: May 12, 2016

(54) THERMOPLASTIC RESIN COMPOSITION AND MOLDED ARTICLE MADE THEREFROM

(71) Applicant: Samsung Electronics Co., Ltd., Suwon-si (KR)

(72) Inventors: Seungjoon Hwang, Seoul (KR); Kyunghae Lee, Incheon (KR); Chansu Kim, Seoul (KR); Jun Chwae, Seoul (KR)

(21) Appl. No.: 14/812,828

(22) Filed: Jul. 29, 2015

(30) Foreign Application Priority Data
Nov. 11, 2014 (KR) 10-2014-0156249

(51) Int. Cl. C08L 67/04; C08K 5/00

(52) U.S. Cl. CPC C08L 67/04; C08K 5/0016; C08L 2207/04

(57) ABSTRACT

A thermoplastic resin composition including a first thermoplastic polymer and a second thermoplastic polymer, wherein the first thermoplastic polymer is a block copolymer including a plurality of polymer blocks, at least one of the plurality of polymer blocks includes a random copolymer, and at least one structural unit of the first thermoplastic polymer and a structural unit of the second thermoplastic polymer are stereoisomers, a molded article made therefrom, and methods of making the same.

### RELATED APPLICATION

This application claims the benefit of Korean Patent Application No. 10-2014-0156249, filed on Nov. 11, 2014, in the Korean Intellectual Property Office, the entire disclosure of which is hereby incorporated by reference.

### BACKGROUND

1. Field

The present disclosure relates to thermoplastic resin compositions and molded articles made from the thermoplastic resin compositions.

2. Description of the Related Art

Interest in biodegradable resins, such as aliphatic polyesters, has increased in view of environmental protection. Among the biodegradable resins, polylactic acid (or polylactide) has a high melting point of about 160° C. to about 170° C. and its transparency is excellent. Also, lactic acid, as a raw material of the polylactic acid, may be obtained from renewable resources such as plants. Furthermore, since decomposition products of the polylactic acid are lactic acid, carbon dioxide, and water which are harmless to the human body, the polylactic acid may be used for various applications such as medical supplies.

Polylactic acid has higher strength than a typical resin such as high impact polystyrene (HIPS) and acrylonitrile-butadiene-styrene (ABS), but has poor impact resistance and heat resistance. Thus, there is a need to improve the impact resistance and heat resistance of the polylactic acid.

In a case where a typical impact modifier capable of improving the impact resistance of the polylactic acid is added, the impact resistance of the polylactic acid may be improved, but the heat resistance may be reduced. In a case where a typical heat resistance modifier capable of improving the heat resistance of the polylactic acid is added, the heat resistance of the polylactic acid may be improved, but the impact resistance may be reduced.

Therefore, there is a need to develop polylactic acid polymers with improved impact resistance without substantial reduction of the heat resistance.

### SUMMARY

Provided is a thermoplastic resin composition comprising a first thermoplastic polymer; and a second thermoplastic polymer, wherein the first thermoplastic polymer is a block copolymer including a plurality of polymer blocks, wherein at least one of the plurality of polymer blocks comprises a random copolymer, wherein the first and second thermoplastic polymers each comprise at least one structural unit and at least one structural unit of the first thermoplastic polymer and a structural unit of the second thermoplastic polymer are stereoisomers.

Provided is a method of preparing a thermoplastic resin composition comprising contacting a first thermoplastic polymer with a second thermoplastic polymer, wherein the first thermoplastic polymer is a block copolymer including a plurality of polymer blocks, wherein at least one of the plurality of polymer blocks comprises a random copolymer, wherein the first and second thermoplastic polymers each comprise at least one structural unit and wherein at least one structural unit of the first thermoplastic polymer and a structural unit of the second thermoplastic polymer are stereoisomers.

Provided is a method of making a molded article, the method comprising molding the thermoplastic resin composition into a desired shape.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a transmission electron microscope (TEM) image of a thermoplastic resin composition prepared in Example 5;

FIG. 2 is the result of differential scanning calorimetry (DSC) analysis of the thermoplastic resin composition prepared in Example 5;

FIG. 3 is the result of evaluating impact resistances of thermoplastic resin compositions prepared in Examples 5 to 7 and Comparative Example 6; and

FIG. 4 is the result of evaluating impact resistances of thermoplastic resin compositions prepared in Examples 8 to 10 and Comparative Example 6.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a thermoplastic resin composition according to exemplary embodiments and a molded article made from the thermoplastic resin composition will be described in more detail.

It will be understood that the terms “comprises” “including,” “includes” and/or “comprising” used herein specify the presence of stated elements or components without any specific limitations, but do not preclude the presence or addition of one or more other elements or components.

In the present specification, the expression “lactide” includes L-lactide formed of L-lactic acid, D-lactide formed of D-lactic acid, and meso-lactide formed of L-lactic acid and D-lactic acid.

In the present specification, the expression “polylactic acid” (PLA) denotes all polymers including a repeating unit that is formed by ring-opening polymerization of a lactide monomer or direct polymerization of lactic acid. The polymer includes a homopolymer or a copolymer, and is not limited thereto. For example, the polymer includes may include a crude or purified polymer after the completion of the ring-opening polymerization or the direct polymerization, a polymer included in a liquid or solid resin composition before product molding, or a polymer included in a plastic, film, or textile after the completion of a product molding process.

In the present specification, the term “structural unit” refers to a building block of polymer chain that is prepared from a monomer.

In the present specification, the expression “poly-L-lactic acid” (PLLA) denotes a polymer formed of a structural unit derived from L-lactic acid that is formed by ring-opening polymerization of an L-lactide monomer or by direct polymerization of an L-lactic acid monomer. In the present specification, the expression “poly-D-lactic acid” (PDLA) denotes a polymer formed of a structural unit derived from D-lactic acid that is formed by ring-opening polymerization of a D-lactide monomer or by direct polymerization of a D-lactic acid monomer.

In the present specification, the expression “stereoisomer” includes isomers in an enantiomeric relation in which the isomers have the same chemical formula and structural formula but have different three-dimensional configurations from one another. For example, when one polymer is a stereoisomer of other polymer, a structural unit included in the one polymer and a structural unit included in the other polymer may include a chiral center while having the same chemical formula, but have a mirror-image relationship to each other. For example, one polymer of two kinds of polymers which are stereoisomers may be named as a chiral polymer and the other polymer may be named as an anti-chiral polymer.

In the present specification, the expression “random copolymer” denotes a polymer in which structural units derived from two or more monomers are randomly linked by a covalent bond. In other words, the two or more monomers occurring in the random copolymer may be arranged in any order (e.g., a random order), as opposed, for instance, to an alternating copolymer in which the monomers of the copolymer alternate, or a block copolymer in which the monomers of each copolymer are grouped together.

In the present specification, the expression “block copolymer” denotes a copolymer including two or more polymer blocks that include different structural units and are linked by a covalent bond. Each polymer block can, itself, be a homopolymer or copolymer of any type (random, alternating, etc.).

In the present specification, the expression “thermoplastic resin” denotes a resin in which flexibility increases as the temperature increases.

In the present specification, the expression “monomer” denotes a single-molecule compound which may form a structural unit of a polymer by being used in the preparation of the polymer.

A thermoplastic resin composition according to an embodiment of the present invention includes a first thermoplastic polymer; and a second thermoplastic polymer, wherein the first thermoplastic polymer is a block copolymer including a plurality of polymer blocks, and at least one of the plurality of polymer blocks includes a random copolymer. Further, at least one structural unit of the first thermoplastic polymer and a structural unit of the second thermoplastic polymer are stereoisomers of one another.

The first thermoplastic polymer includes a polymer block formed of a random copolymer. The polymer block formed of a random copolymer may decrease the glass transition temperature or melting point of the polymer block by randomly including a plurality of different structural units. Thus, the flexibility of the polymer block may increase. For example, with respect to a crystalline polymer, flexibility may be increased by suppressing crystallization which typically occurs in a homopolymer block that is formed of a single type of structural unit. The flexibility of the first thermoplastic polymer may be increased by including the polymer block that is formed of a random copolymer having increased flexibility. As a result, the impact resistance of the thermoplastic resin composition including the first thermoplastic polymer, which includes a random copolymer block having increased flexibility, may be improved compared, for instance, to a comparative resin as set forth in the Examples.

Further, since the at least one structural unit among the plurality of structural units included in the first thermoplastic polymer and a structural unit of the second thermoplastic polymer are stereoisomers, these structural units may form a stereo complex. That is, the first thermoplastic polymer and the second thermoplastic polymer may physically form a stereo complex to improve the thermal stability of the resin composition. Since the first thermoplastic polymer and the second thermoplastic polymer bind strongly to each other, a melting point of the resin composition may be increased compared, for instance, to a comparative resin as set forth in the Examples.

The random copolymer may include two or more structural units of two or more monomers which are selected from the group consisting of an ether-group containing monomer, an olefin-group containing monomer, a vinyl-group containing monomer, a polyol-group containing monomer, a polybasic acid-group containing monomer, an isocyanate-group containing monomer, an acrylate-group containing monomer, a vinyl alcohol-group containing monomer, an ethylene-group containing monomer, an ester-group containing monomer, a silicon-group containing monomer, and a lactone-group containing monomer.

The random copolymer may include two or more structural units of two or more monomers which are selected from the group consisting of lactic acid, styrene, vinylnaphthalene, methyl methacrylate, caprolactone, valerolactone, butyrolactone, butadiene, isobutylene, styrene-butadiene, methylsiloxane, ethylene, propylene, 1-butene, 4-methyl-pentene, norbornenyl ethyl styrene, hexamethyl carbonate, hexyl norbornene, butyl succinate, dicyclopentadiene, cyclohexylethylene, 1,5-dioxepane-2-on, 4-vinylpyridine, isoprene, 3-hydroxybutyrate, 2-hydroxy methacrylate, N-vinyl-2-pyrrolidone, 4-acryloyl morpholine, ethylene oxide, ethylene glycol, acrylonitrile, a vegetable oil derivative, propylene glycol, tetramethylene ether glycol, para-dioxanone, propylene carbonate, tetramethyleneadipate, terephthalate, butylene adipate, and butylene succinate.

The random copolymer may include a structural unit derived from a monomer that provides elasticity to a polymer and a second structural unit derived from a monomer that has a different structure therefrom. For example, the monomer providing elasticity to a polymer may include at least one monomer selected from the group consisting of an ether-based monomer, an olefin-group containing monomer, a vinyl-group containing monomer, a polyol-group containing monomer, an isocyanate-group containing monomer, an acrylate-group containing monomer, an ester-group containing monomer, a silicon-group containing monomer, and a lactone-group containing monomer.

The monomer that provides elasticity to a polymer may include at least one monomer selected from the group consisting of caprolactone, valerolactone, butyrolactone, butadiene, isobutylene, styrene-butadiene, methylsiloxane, ethylene, propylene, 1-butene, 4-methyl-pentene, hexamethyl carbonate, hexyl norbornene, butyl succinate, dicyclopentadiene, 1,5-dioxepane-2-on, isoprene, 3-hydroxybutyrate, ethylene oxide, ethylene glycol, acrylonitrile, a vegetable oil derivative, propylene glycol, tetramethylene ether glycol, para-dioxanone, propylene carbonate, butylene adipate, and butylene succinate.

The monomer of the random copolymer that has a different structure from the monomer providing elasticity is not particularly limited so long as it is a monomer capable of forming a random copolymer with the monomer providing elasticity to a polymer.

For example, the random copolymer may include a first structural unit derived from D-lactic acid and a second structural unit derived from a monomer having a different structure from the D-lactic acid. Specifically, the random copolymer may include the first structural unit derived from D-lactic acid and the second structural unit derived from caprolactone.

The random copolymer may have a composition including about 10 wt % to about 50 wt % of the first structural unit and about 50 wt % to about 90 wt % of the second structural unit. For example, the random copolymer may include about 10 wt % to about 40 wt % of the first structural unit and about 60 wt % to about 90 wt % of the second structural unit. For example, the random copolymer may include about 10 wt % to about 30 wt % of the first structural unit and about 70 wt % to about 90 wt % of the second structural unit. For example, the random copolymer may include about 10 wt % to about 25 wt % of the first structural unit and about 75 wt % to about 90 wt % of the second structural unit. A thermoplastic resin composition having improved impact resistance and heat resistance may be obtained by mixing the block copolymer which includes the random copolymer block in the ranges described above of the first structural unit and the second structural unit but is not limited thereto. In a case where the amount of the first structural unit is excessively low, crystallinity of the polymer block including the random copolymer may be increased to reduce the impact resistance. For example, the random copolymer substantially has the same physical properties as polycaprolactone, and thus, compatibility with poly-L-lactic acid may be reduced. In a case where the amount of the first structural unit is excessively high, the random copolymer, for example, may have the same physical properties as poly-D-lactic acid, and thus, the impact resistance may be reduced. For example, the random copolymer may include about 10 wt % to about 50 wt % of the structural unit derived from D-lactic acid and about 50 wt % to about 90 wt % of the structural unit derived from caprolactone.

Alternatively, a weight ratio of the first structural unit to the second structural unit in the random copolymer may be in a range of about 10:90 to about 50:50. For example, the weight ratio of the first structural unit to the second structural unit in the random copolymer may be in a range of about 10:90 to about 25:75. For example, the weight ratio of the structural unit derived from D-lactic acid to the structural unit derived from caprolactone may be in a range of about 10:90 to about 50:50.

A glass transition temperature (T_{g}) of the random copolymer may be lower than about 0° C. For example, the T_{g} of the random copolymer may be in a range of lower than about 0° C. to about −50° C. For example, the T_{g} of the random copolymer may be in a range of about −20° C. to about −50° C. For example, the T_{g} of the random copolymer may be in a range of about −25° C. to about −50° C. For example, the T_{g} of the random copolymer may be in a range of about −30° C. to about −50° C. Since the glass transition temperature of the random copolymer is lower than about 0° C., the impact resistance of the thermoplastic resin composition, in which the block copolymer including the polymer block that is formed of the random copolymer is mixed, may be improved compared, for instance, to a comparative resin as set forth in the Examples. In a case where the glass transition temperature of the random copolymer is excessively low, the flexibility of the random copolymer may increase, and thus, toughness may be reduced. In a case where the glass transition temperature is excessively high, the impact resistance may be reduced.

A weight-average molecular weight of the random copolymer may be in a range of about 30,000 Daltons to about 100,000 Daltons as determined by Gel Permeation Chromatography (GPC). For example, the weight-average molecular weight of the random copolymer may be in a range of about 30,000 Daltons to about 85,000 Daltons. For example, the weight-average molecular weight of the random copolymer may be in a range of about 30,000 Daltons to about 70,000 Daltons. A thermoplastic resin composition having improved impact resistance may be obtained within the above weight-average molecular weight range of the random copolymer. In a case where the weight-average molecular weight of the random copolymer is excessively low, since the flexibility is low, the impact resistance may be reduced. In a case where the weight-average molecular weight of the random copolymer is excessively high, since the flexibility excessively increases, the heat resistance of the entire resin composition may be reduced.

The block copolymer may include a first polymer block including a random copolymer and a second polymer block including a homopolymer. Since the block copolymer includes the polymer block including a random copolymer, the impact resistance of the thermoplastic resin composition including the block copolymer may be improved compared, for instance, to a comparative resin as set forth in the Examples . . . . Also, since the block copolymer includes the polymer block including a homopolymer the homoploymer may form a stereo complex with the second thermoplastic polymer, the heat resistance of the thermoplastic resin composition may be improved compared, for instance, to a comparative resin as set forth in the Examples. For example, the homopolymer may be poly-D-lactic acid.

The block copolymer may include about 50 wt % to about 90 wt % of the first polymer block including a random copolymer and about 10 wt % to about 50 wt % of the second polymer block including a homopolymer. For example, the block copolymer may include about 50 wt % to about 80 wt % of the first polymer block and about 20 wt % to about 50 wt % of the second polymer block. For example, the block copolymer may include about 50 wt % to about 70 wt % of the first polymer block and about 30 wt % to about 50 wt % of the second polymer block. A thermoplastic resin composition having improved impact resistance and heat resistance may be obtained within the above range of the first polymer block and the second polymer block compared, for instance, to a comparative resin as set forth in the Examples. In a case where the amount of the first polymer block is excessively low, the flexibility of the block copolymer is reduced, and thus, the impact resistance of the thermoplastic resin composition may be reduced. In a case where the amount of the first polymer block is excessively high, the flexibility of the block copolymer is increased, and thus, the toughness of the resin composition including the block copolymer may be reduced.

Alternatively, a weight ratio of the first polymer block to the second polymer block in the block copolymer may be in a range of about 50:50 to about 90:10. For example, the weight ratio of the first polymer block to the second polymer block in the block copolymer may be in a range of about 50:50 to about 70:30.

A weight-average molecular weight of the block copolymer including a random copolymer block may be in a range of about 50,000 Daltons to about 150,000 Daltons. For example, the weight-average molecular weight of the block copolymer may be in a range of about 50,000 Daltons to about 100,000 Daltons. For example, the weight-average molecular weight of the block copolymer may be in a range of about 50,000 Daltons to about 80,000 Daltons. A thermoplastic resin composition having improved impact resistance and heat resistance may be obtained within the above weight-average molecular weight range of the block copolymer compared, for instance, to a comparative resin as set forth in the Examples. In a case where the weight-average molecular weight of the block copolymer is excessively low, since the block copolymer may exhibit the same characteristics as the random copolymer, the heat resistance of the resin composition may be decreased. In a case where the weight-average molecular weight of the block copolymer is excessively high, since the block copolymer may exhibit the same characteristics as poly-D-lactic acid (PDLA), the impact strength of the resin composition may be reduced.

For example, a block copolymer, which includes a polymer block including a random copolymer of caprolactone and D-lactic acid and a homopolymer block including monomers of poly-D-lactic acid, may be represented by Chemical Formula 1 below.

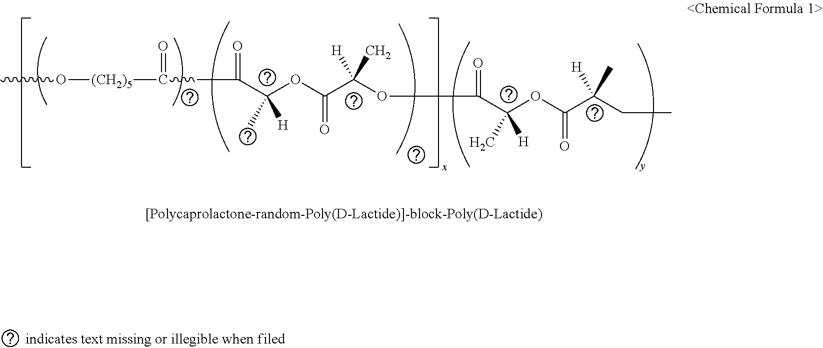

In the above formula, n is a weight fraction of the caprolactone structural unit, m is a weight fraction of the D-lactic acid structural unit, x is a weight fraction of the random copolymer block, y is a weight fraction of the homopolymer block, n+m=1 and x+y=1, 0.5≦n≦0.9, 0.1≦m≦0.5, 0.5≦x≦0.9, and 0.1≦y≦0.5, and a weight-average molecular weight is in a range of about 50,000 Daltons to about 150,000 Daltons.

The block copolymer may have a first melting point of about 30° C. to about 60° C. and a second melting point of about 110° C. to about 170° C. The first melting point corresponds to a melting point of the polymer block including a random copolymer, and the second melting point corresponds to a melting point of the polymer block including a homopolymer. For example, the block copolymer may have a first melting point of about 30° C. to about 60° C. and a second melting point of about 110° C. to about 165° C. For example, the block copolymer may have a first melting point of about 30° C. to about 55° C. and a second melting point of about 110° C. to about 160° C. For example, the block copolymer may have a first melting point of about 30° C. to about 50° C. and a second melting point of about 110° C. to about 155° C. Since the block copolymer may simultaneously have a first melting point of about 60° C. or less and a second melting point of about 110° C. or more, the impact resistance and heat resistance of the thermoplastic resin composition including the block copolymer may be improved compared, for instance, to a comparative resin as set forth in the Examples. In a case where the first melting point due to the polymer block including a random copolymer is excessively high, the flexibility of the block copolymer is reduced, and thus, the impact resistance of the thermoplastic resin composition may be reduced. In a case where the second melting point due to the polymer block including a homopolymer is excessively low, the mechanical toughness of the thermoplastic resin composition may be reduced.

In the thermoplastic resin composition, the second thermoplastic polymer may be poly-L-lactic acid. The poly-L-lactic acid, as a polymer including a lactic acid structural unit of the following Chemical Formula 2, is a chiral polymer including a chiral center in the lactic acid structural unit and is poly-S-lactic acid when expressed according to an R/S configuration. The poly-L-lactic acid may form a stereo complex with a poly-D-lactic acid block, as an enantiomer, included in the block copolymer.

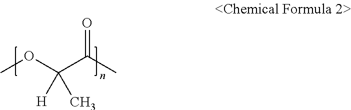

When the at least one structural unit of the first thermoplastic polymer includes D-lactic acid, the second thermoplastic polymer may be poly-L-lactic acid including L-lactic acid which is a stereoisomer of the D-lactic acid. Further, when the at least one structural unit of the first thermoplastic polymer includes L-lactic acid, the second thermoplastic polymer may be poly-D-lactic acid including D-lactic acid which is a stereoisomer of the L-lactic acid.

A weight-average molecular weight of the poly-L-lactic acid may be in a range of about 10,000 Daltons to about 500,000 Daltons. For example, the weight-average molecular weight of the poly-L-lactic acid may be in a range of about 100,000 Daltons to about 300,000 Daltons. In a case where the weight-average molecular weight of the poly-L-lactic acid is less than about 10,000, mechanical properties of the thermoplastic resin composition may deteriorate, and in a case where the weight-average molecular weight of the poly-L-lactic acid is greater than about 500,000 Daltons, processing may be difficult.

The optical purity of the poly-L-lactic acid may be about 90% or more. For example, the optical purity of the poly-L-lactic acid may be about 93% or more. For example, the optical purity of the poly-L-lactic acid may be about 95% or more. For example, the optical purity of the poly-L-lactic acid may be about 97% or more. When the optical purity of the poly-L-lactic acid is about 90% or less, the mechanical properties may deteriorate.

The thermoplastic resin composition may include about 5 wt % to about 30 wt % of the first thermoplastic polymer based on a total weight of the thermoplastic resin composition. For example, the thermoplastic resin composition may include about 10 wt % to about 30 wt % of the first thermoplastic polymer based on the total weight of the thermoplastic resin composition. For example, the thermoplastic resin composition may include about 10 wt % to about 25 wt % of the first thermoplastic polymer based on the total weight of the thermoplastic resin composition. A thermoplastic resin composition having improved impact resistance and heat resistance may be obtained within the above range of the first thermoplastic polymer compared, for instance, to a comparative resin as set forth in the Examples. In a case where the amount of the first thermoplastic polymer is excessively low, since it corresponds to a case where the thermoplastic resin composition substantially includes only the second thermoplastic polymer, the impact resistance of the thermoplastic resin composition may be reduced. In a case where the amount of the first thermoplastic polymer is excessively high, the toughness of the thermoplastic resin composition at room temperature may be reduced and the heat resistance may also be reduced.

The thermoplastic resin composition may include about 65 wt % to about 90 wt % of the second thermoplastic polymer based on the total weight of the thermoplastic resin composition. For example, the thermoplastic resin composition may include about 70 wt % to about 90 wt % of the second thermoplastic polymer based on the total weight of the thermoplastic resin composition. For example, the thermoplastic resin composition may include about 75 wt % to about 90 wt % of the second thermoplastic polymer based on the total weight of the thermoplastic resin composition. A thermoplastic resin composition having improved impact resistance and heat resistance may be obtained within the above range of the second thermoplastic polymer. In a case where the amount of the second thermoplastic polymer is excessively low, the toughness of the thermoplastic resin composition at room temperature may be reduced and the heat resistance may also be reduced. In a case where the amount of the second thermoplastic polymer is excessively high, since it corresponds to a case where the thermoplastic resin composition substantially includes only the second thermoplastic polymer, the impact resistance of the thermoplastic resin composition may be reduced.

A weight ratio of the first thermoplastic polymer to the second thermoplastic polymer in the thermoplastic resin composition may be in a range of about 5:95 to about 35:65. For example, the weight ratio of the first thermoplastic polymer to the second thermoplastic polymer in the thermoplastic resin composition may be in a range of about 10:90 to about 30:70. For example, the weight ratio of the first thermoplastic polymer to the second thermoplastic polymer in the thermoplastic resin composition may be in a range of about 10:90 to about 20:80.

The thermoplastic resin composition may further include a plasticizer. In embodiments where the thermoplastic resin composition further includes the plasticizer, the impact resistance and heat resistance of the thermoplastic resin composition may be further improved compared, for instance, to a comparative resin as set forth in the Examples.

In one embodiment, a synthetic plasticizer and a vegetable plasticizer may be respectively used or may be mixed to be used as the plasticizer. An amount of the plasticizer may be in a range of about 1 wt % to about 5 wt % based on the total weight of the thermoplastic resin composition. For example, the amount of the plasticizer may be in a range of about 1 wt % to about 4 wt % based on the total weight of the thermoplastic resin composition. For example, the amount of the plasticizer may be in a range of about 2 wt % to about 4 wt % based on the total weight of the thermoplastic resin composition. The impact resistance and heat resistance of the thermoplastic resin composition may be improved within the above range of the plasticizer compared, for instance, to a comparative resin as set forth in the Examples. In a case where the amount of the plasticizer is excessively low, the plasticizer may not play a role, and in a case where the amount of the plasticizer is excessively high, the heat resistance of the thermoplastic resin composition may be reduced.

The synthetic plasticizer may include a phthalate-based plasticizer, an adipate-based plasticizer, a silicon-based plasticizer, a mixture of trimethylolpropane-tri(2-ethylhexanoate) and benzoic acid, a mixture of 2,2-bis(2-ethylhexa-noyloxymethyl)butyl ester and 2-ethylhexoic acid, a mixture of 2,2-bis(bezoyloxy-methyl)butyl ester and trimethylol propane-tribenzoate, a mixed alcohol ester, a citric acid ester, or a combination thereof.

Specific examples of the synthetic plasticizer may be dioctylterephthalate, dioctyl(nonyl)terephthalate, a mixture of trimethylolpropane-tri(2-ethylhexanoate) and benzoic acid, a mixture of 2,2-bis(2-ethylhexa-noyloxymethyl)butyl ester and 2-ethylhexoic acid, a mixture of 2,2-bis(bezoyloxy-methyl)butyl ester and trimethylol propane-tribenzoate, a mixed alcohol ester, a citric acid ester, or a combination thereof.

The vegetable plasticizer may be vegetable oil or modified vegetable oil. The modified vegetable oil is a reaction product of vegetable oil and other monomers. The modification, for example, may include expoxydization, maleinization, or acrylation. The vegetable oil may include soybean oil, linseed oil, palm oil, or a combination thereof. The modified vegetable oil may include epoxidized soybean oil, acrylated soybean oil, maleated soybean oil, acrylated-epoxydized soybean oil, or a combination thereof.

For example, the plasticizer may be a reactive plasticizer. The reactive plasticizer may be disposed on the surface of the first thermoplastic polymer to form a surface morphology of the first thermoplastic polymer in the thermoplastic resin composition. Further, since a reactive functional group, such as an epoxy group, may form a bond with the first thermoplastic polymer and/or the second thermoplastic polymer, the reactive plasticizer may increase a binding force between the first thermoplastic polymer and the second thermoplastic polymer.

The thermoplastic resin composition may include about 5 wt % to about 30 wt % of the first thermoplastic polymer, about 65 wt % to about 90 wt % of the second thermoplastic polymer, and about 1 wt % to about 5 wt % of the plasticizer based on the total weight of the resin composition. For example, the thermoplastic resin composition may include about 5 wt % to about 25 wt % of the first thermoplastic polymer, about 70 wt % to about 90 wt % of the second thermoplastic polymer, and about 1 wt % to about 5 wt % of the plasticizer based on the total weight of the resin composition. For example, the thermoplastic resin composition may include about 5 wt % to about 20 wt % of the first thermoplastic polymer, about 75 wt % to about 90 wt % of the second thermoplastic polymer, and about 1 wt % to about 5 wt % of the plasticizer based on the total weight of the resin composition. For example, the thermoplastic resin composition may include about 5 wt % to about 15 wt % of the first thermoplastic polymer, about 80 wt % to about 90 wt % of the second thermoplastic polymer, and about 1 wt % to about 5 wt % of the plasticizer based on the total weight of the resin composition. Improved impact resistance and heat resistance may be obtained within the above composition range of the thermoplastic resin composition compared, for instance, to a comparative resin as set forth in the Examples.

Further, the thermoplastic resin composition may further include a nucleating agent. When the thermoplastic resin composition includes a nucleating agent, the heat resistance may be further improved by improving the crystallization rate of the polylactic acid.

An amount of the nucleating agent may be in a range of about 0.1 wt % to about 10 wt % based on the total weight of the thermoplastic resin composition. For example, the amount of the nucleating agent may be in a range of about 0.1 wt % to about 6 wt % based on the total weight of the thermoplastic resin composition. For example, the amount of the nucleating agent may be in a range of about 0.1 wt % to about 4 wt % based on the total weight of the thermoplastic resin composition. For example, the amount of the nucleating agent may be in a range of about 0.5 wt % to about 3 wt % based on the total weight of the thermoplastic resin composition. In a case where the amount of the nucleating agent is included within the above range, the impact resistance and heat resistance of the thermoplastic resin composition may be improved compared, for instance, to a comparative resin as set forth in the Examples.

An average particle diameter of the nucleating agent may be about 100 μm or less. For example, the average particle diameter of the nucleating agent may be in a range of about 1 μm to about 100 μm. For example, the average particle diameter of the nucleating agent may be in a range of about 1 μm to about 50 μm or less. For example, the average particle diameter of the nucleating agent may be in a range of about 1 μm to about 30 μm or less. The heat resistance of the thermoplastic resin composition may be further improved by using the nucleating agent having the above particle diameter range.

Any nucleating agent can be used. The nucleating agent of a resin composition may be any one of an inorganic-based nucleating agent and an organic-based nucleating agent may be used as the nucleating agent. Specific examples of the inorganic-based nucleating agent may be talc, kaolinite, montmorillonite, synthetic mica, clay, zeolite, silica, graphite, carbon black, zinc oxide, magnesium oxide, titanium oxide, calcium sulfide, boron nitride, calcium carbonate, barium sulfate, aluminum oxide, neodymium oxide, and a metal salt of phenylphosphonate. For example, talc, mica, and silica may be used. In particular, talc may be used.

Specific examples of the organic-based nucleating agent may be organic carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate, and sodium cyclohexane carboxylate; organic sulfonates such as sodium p-toluene sulfonate and sodium sulfoisophthalate; carboxylic acid amides such as stearic acid amide, ethylene bislauric acid amide, palmitic acid amide, hydroxystearic acid amide, erucic acid amide, and tris(t-butylamide)trimesate; low-density polyethylene, high-density polyethylene, polypropylene, polyisopropylene, polybutene, poly-4-methylpentene, poly-3-methylbutene-1, polyvinylcycloalkane, polyvinyltrialkylsilane; sodium salts or potassium salts of a polymer having a carboxyl group (so-called ionomers) such as a sodium salt of an ethylene-acrylic acid or a methacrylic acid copolymer and a sodium salt of a styrene-maleic anhydride copolymer; benzylidene sorbitol and a derivative thereof; phosphate ester metal salts such as ADEKA products NA-11 and NA-71; and 2,2-methylbis(4,6-di-t-butylphenyl)sodium. For example, ethylene bislauric acid amide, benzylidene sorbitol and a derivative thereof, organic carboxylic acid metal salts, carboxylic acid amides, and phosphate ester metal salts, such as ADEKA products NA-11 and NA-71, may be used. One of the above organic-based nucleating agents may be used alone as the nucleating agent, or two or more thereof may be mixed to be used as the nucleating agent.

The thermoplastic resin composition may be a liquid or solid at room temperature and pressure (25° C., 1 atm), and may be molded into a final product (e.g., a molded article, a film, or a textile). The final product (e.g., molded article, textile, or film) may be manufactured by methods known in the art.

The thermoplastic resin composition may further include other additives typically used in resin compositions. For example, the additive, such as a filler, a terminal blocking agent, a metal deactivator, an antioxidant, a heat stabilizer, an ultraviolet absorber, a lubricant, a tackfier, a plasticizer, a cross-linking agent, a viscosity modifier, an antistatic agent, a flavouring agent, an antibacterial agent, a dispersant, and a polymerization inhibitor, may be added within a range that does not adversely affect the physical properties of the resin composition.

Fillers include, for example, an inorganic filler, such as talc, wollastonite, mica, clay, montmorillonite, smectite, kaoline, zeolite (aluminum silicate), and anhydrous amorphous aluminum silicate obtained by performing an acid treatment and a heat treatment on zeolite, may be used as the filler. In a case where the filler is included, an amount of the filler in the resin composition may be in a range of about 1 wt % to about 20 wt % based on the total weight of the resin composition in order to maintain impact strength of the molded article.

The thermoplastic resin composition may include a carbodiimide compound, such as a polycarbodiimide compound or a monocarbodiimide compound, as the terminal blocking agent. Since the above compound reacts with a part or all of a terminal carboxyl group of a polylactic acid resin to block side reactions such as hydrolysis, water resistance of the molded article including the thermoplastic resin composition may be improved. Thus, durability of the molded article including the thermoplastic resin composition under high temperature and high humidity environments may be improved compared, for instance, to a comparative resin as set forth in the Examples.

The polycarbodiimide compound, for example, may include poly(4,4′-diphenylmethane carbodiimide), poly(4,4′-dicyclohexylmethane carbodiimide), poly(1,3,5-triisopropyl benzene)polycarbodiimide, and poly(1,3,5-triisopropylbenzene and 1,5-diisopropylbenzene)polycarbodiimide. The monocarbodiimide compound, for example, may include N,N′-di-2,6-diisopropylphenyl carbodiimide.

An amount of the carbodiimide compound may be in a range of about 0.1 wt % to about 3 wt % based on the total weight of the thermoplastic resin composition. In a case where the amount of the carbodiimide compound is less than about 0.1 wt %, the improvement of the durability of the molded article may be insignificant, and in a case where the amount of the carbodiimide compound is greater than about 3 wt %, the mechanical toughness of the molded article may deteriorate.

The thermoplastic resin composition may include a stabilizer or a colorant in order to stabilize the molecular weight or color during molding. A phosphorus-based stabilizer, a hindered phenol-based stabilizer, an ultraviolet absorber, a heat stabilizer, and an antistatic agent may be used as the stabilizer.

Phosphorous acid, phosphoric acid, phosphonic acid, esters thereof (phosphite compound, phosphate compound, phosphonite compound, phosphonate compound, etc.), and tertiary phosphine may be used as the phosphorus-based stabilizer.

Sandostab P-EPQ (Clariant) and Irgafos P-EPQ (CIBA SPECIALTY CHEMICALS) may be used as a stabilizer including the phosphonite compound as a main component.

PEP-8 (Asahi Denka Kogyo), JPP681S (Tohoku Chemical Co., Ltd.), PEP-24G (Asahi Denka Kogyo), Alkanox P-24 (Great Lakes), Ultranox P626 (GE Specialty Chemicals), Doverphos S-9432 (Dover Chemical), Irgaofos126, 126 FF (CIBA SPECIALTY CHEMICALS), PEP-36 (Asahi Denka Kogyo), PEP-45 (Asahi Denka Kogyo), and Doverphos S-9228 (Dover Chemical) may be used as a stabilizer including the phosphite compound as a main component.

Hindered phenol-based stabilizers (antioxidants) include any compounds typically used in resin compositions for this purpose. For example, 3,9-bis[2-{3-(3-t-butyl-4-hydroxy-5-methylphenyl)propionyloxy}-1,1-dimethylethyl]-2,4,8,10-tetraoxaspiro[5,5]undecane may be used as the hindered phenol-based stabilizer. However, the hindered phenol-based stabilizer is not limited thereto, and any hindered phenol-based compound may be used as the hindered phenol-based stabilizer so long as it is used as an oxidation stabilizer of a resin composition in the art.

An amount of the phosphorus-based stabilizer and the hindered phenol-based antioxidant in the resin composition may be in a range of about 0.005 wt % to about 1 wt % based on the total weight of the resin composition.

The thermoplastic resin composition may include an ultraviolet absorber. The deterioration of weather resistance of the molded article due to the effect of a rubber component or flame retardant may be suppressed by including the ultraviolet absorber. A benzophenone-based ultraviolet absorber, a benzotriazole-based ultraviolet absorber, a hydroxyphenyltriazine-based ultraviolet absorber, a cyclic imino ester-based ultraviolet absorber, and a cyanoacrylate-based ultraviolet absorber may be used as the ultraviolet absorber. An amount of the ultraviolet absorber in the thermoplastic resin composition may be in a range of about 0.01 wt % to about 2 wt % based on the total weight of the resin composition.

The thermoplastic resin composition may include a dye or pigment as a colorant in order to provide various colors to the molded article.

The thermoplastic resin composition may include an antistatic agent in order to provide antistatic performance to the molded article.

The thermoplastic resin composition may contain a thermoplastic resin other than the above-described resin, a flow modifier, an antibacterial agent, a dispersant such as liquid paraffin, a photocatalytic antifouling agent, an infra-red (IR) absorber, and a photochromic agent.

An impact strength of the thermoplastic resin composition may be about 110 J/m or more. For example, the impact strength of the thermoplastic resin composition may be in a range of about 110 J/m to about 800 J/m. The impact strength of the thermoplastic resin composition may be in a range of about 120 J/m to about 800 J/m. For example, the impact strength of the thermoplastic resin composition may be in a range of about 250 J/m to about 800 J/m. For example, the impact strength of the thermoplastic resin composition may be in a range of about 750 J/m to about 800 J/m. Since the thermoplastic resin composition has an impact strength of about 110 J/m or more, an article prepared using the thermoplastic resin composition may have improved durability compared, for instance, to a comparative resin as set forth in the Examples.

A melting point (Tₘ_{_}_{sc}) of the stereo complex, which is formed by combining the first thermoplastic polymer and the second thermoplastic polymer that are included in the thermoplastic resin composition, may be about 180° C. or more. For example, the melting point (Tₘ_{_}_{sc}) of the stereo complex in the thermoplastic resin composition may be about 182° C. or more. For example, the melting point (Tₘ_{_}_{sc}) of the stereo complex in the thermoplastic resin composition may be about 184° C. or more. For example, the melting point (Tₘ_{_}_{sc}) of the stereo complex in the thermoplastic resin composition may be about 190° C. or more. For example, the melting point (Tₘ_{_}_{sc}) of the stereo complex in the thermoplastic resin composition may be about 195° C. or more. Since the stereo complex included in the thermoplastic resin composition has a melting point of about 180° C. or more, an article prepared using the thermoplastic resin composition may have improved heat resistance.

Provided is a method of preparing a thermoplastic resin composition as described herein, the method comprising combining a first thermoplastic polymer with a second thermoplastic polymer, wherein the first thermoplastic polymer is a block copolymer including a plurality of polymer blocks, wherein at least one of the plurality of polymer blocks comprises a random copolymer, and wherein at least one structural unit of the first thermoplastic polymer is a stereoisomer of a structural unit of the second thermoplastic polymer.

Also provided is a molded article comprising the thermoplastic resin composition described herein, as well as a method of making a molded article by forming the thermoplastic resin composition into a desired shape. The molded article may be obtained by melt-kneading each component constituting the resin composition with various types of extruders, a Banbury mixer, a kneader, a continuous kneader, and a roll. During the kneading, the above each component may be added collectively or dividedly. The thermoplastic resin composition thus prepared may be used to obtain a molded article by a known molding method such as injection molding, press molding, calendar molding, T-die extrusion molding, hollow sheet extrusion molding, foam sheet extrusion molding, inflation molding, lamination molding, vacuum molding, profile extrusion molding, or a combined method thereof.

Further, in a case where a kneader, such as a kneading extruder and a Banbury mixer, is connected to a calendar molding machine, T-die extrusion molding machine, or inflation molding machine, the thermoplastic resin composition is not first prepared, but a molded article may be prepared at the same time when the thermoplastic resin composition is obtained by the connected kneader.

The molded article prepared using the thermoplastic resin composition may be used for various applications without any restriction. For example, the molded article may be used as interior and exterior materials of various general-purpose items. For example, the molded article may be used as interior and exterior materials of household appliances, communication equipment, and industrial equipment. Also, the molded article may be used in generic product areas such as cases such as a relay case, a wafer case, a reticle case, and a mask case; trays such as a liquid crystal tray, a chip tray, a hard disk tray, a charge coupled device (CCD) tray, an integrated circuit (IC) tray, an organic electroluminescence (EL) tray, an optical pickup tray, and a light-emitting diode (LED) tray; carriers such as an IC carrier; films such as a polarizing film, a light guide plate, protective films for various lenses, a sheet used during cutting a polarizing film, and a sheet used in a clean room such as a partition plate; an inner member of an automatic vending machine, antistatic bags used in a liquid crystal panel, a hard disk, and a plasma panel, corrugated plastic, carrying cases for a liquid crystal panel, a liquid crystal cell, and a plasma panel, and other members for carrying various parts. Also, the molded article may be used for medical use such as a vascular graft, a cell carrier, a drug carrier, and a gene carrier.

The present disclosure is described in more detail according to examples and comparative examples below. However, the examples only exemplify the present disclosure, and the scope of the present disclosure is not limited thereto.

### Preparation of Block Copolymer

### Example 1

### Preparation of Block Copolymer [7(Random)(CL/LD=86/14):3(Block)]

About 12 g of ε-caprolactone (CLN) and about 2 g of D-lactide (DLD) were introduced into a 250 ml glass reactor equipped with a stirrer, a heating device, a condenser, and a vacuum unit in a nitrogen atmosphere, and the temperature was then increased to about 120° C. to remove moisture while stirring at about 50 rpm. Then, about 0.5 wt % of tin(II) 2-ethylhexanoate (Sn(Oct)₂), as a catalyst, was further added and polymerized at about 150° C. for about 1 hour. Once the polymerization was complete, a random copolymer of caprolactone and D-lactide was obtained by removing unreacted caprolactone and D-lactide from the polymerization product under a vacuum of about 20 torr using a vacuum pump.

About 6 g of D-lactide was added to the random copolymer, about 0.5 wt % of tin(II) 2-ethylhexanoate (Sn(Oct)₂), as a catalyst, was further added thereto, and polymerization was performed at about 150° C. for about 0.5 hours.

Once the polymerization was complete, the polymerization product was dissolved in about 120 g of chloroform and was then reprecipitated in about 600 ml of methanol. Then, a block copolymer, in which a poly-D-lactic acid homopolymer block was added to the random copolymer block of caprolactone and D-lactide, was obtained by removing unreacted D-lactide from the precipitate by drying the precipitate at about 50° C. for about 8 hours in a vacuum oven at about 50 torr.

As a result of gel permeation chromatography (GPC) analysis, a weight-average molecular weight of the random copolymer was about 42,000 Daltons, and a weight-average molecular weight of the block copolymer was about 56,000 Daltons.

The GPC analysis was performed using polystyrene as a standard and tetrahydrofuran as a solvent.

As a result of dynamic scanning calorimetry (DSC) analysis, a first melting point due to the random copolymer block was observed at about 35° C. and a second melting point due to the poly-D-lactic acid (PDLA) homopolymer block was observed at about 112° C. The DSC analysis was performed by increasing the temperature at a rate of about 10° C./min from about 25° C. to about 170° C. A glass transition temperature (T_{g}) of the random copolymer was less than about 0° C.

### Example 2

### Preparation of Block Copolymer [7(Random)(CL/LD=90/10):3(Block)]

Polymerization was performed in the same manner as in Example 1 except that the composition of the starting material for the preparation of a random copolymer was changed to about 12.6 g of ε-caprolactone (CLN) and about 1.4 g of D-lactide (DLD).

As a result of GPC analysis, a weight-average molecular weight of the random copolymer was about 65,000 Daltons, and a weight-average molecular weight of the block copolymer was about 77,000 Daltons.

As a result of DSC analysis, a first melting point due to the random copolymer block was observed at about 46° C. and a second melting point due to the PDLA homopolymer block was observed at about 146° C.

### Example 3

### Preparation of Block Copolymer [6(Random)(CL/LD=90/10):4(Block)]

Polymerization was performed in the same manner as in Example 1 except that the composition of the starting material for the preparation of a random copolymer was changed to about 10.8 g of CLN and about 1.2 g of DLD and an amount of D-lactide added to the random copolymer was changed to about 8 g.

As a result of GPC analysis, a weight-average molecular weight of the random copolymer was about 46,000 Daltons, and a weight-average molecular weight of the block copolymer was about 58,000 Daltons.

As a result of DSC analysis, a first melting point due to the random copolymer block was observed at about 45° C. and a second melting point due to the PDLA homopolymer block was observed at about 138° C.

### Example 4

### Preparation of Block Copolymer [5(Random)(CL/LD=90/10):5(Block)]

Polymerization was performed in the same manner as in Example 1 except that the composition of the starting material for the preparation of a random copolymer was changed to about 9 g of CLN and about 1 g of DLD and an amount of D-lactide added to the random copolymer was changed to about 10 g.

As a result of GPC analysis, a weight-average molecular weight of the random copolymer was about 33,000 Daltons, and a weight-average molecular weight of the block copolymer was about 54,000 Daltons.

As a result of DSC analysis, a first melting point due to the random copolymer block was observed at about 44° C. and a second melting point due to the PDLA homopolymer block was observed at about 150° C.

### Comparative Example 1

### Preparation of Random Copolymer [10(Random)(CL/LD=90/10):0(Block)]

About 18 g of CLN and about 2 g of DLD were introduced into a 250 ml glass reactor equipped with a stirrer, a heating device, a condenser, and a vacuum unit in a nitrogen atmosphere, and the temperature was then increased to about 120° C. to remove moisture while stirring at about 50 rpm. Then, about 0.5 wt % of tin(II) 2-ethylhexanoate (Sn(Oct)₂), as a catalyst, was further added and polymerized at about 150° C. for about 1.5 hours. Once the polymerization was complete, the polymerization product was dissolved in about 120 g of chloroform and was then reprecipitated in about 600 ml of methanol. Then, a random copolymer of the caprolactone and D-lactide was obtained by removing unreacted D-lactide from the precipitate by drying the precipitate at about 50° C. for about 8 hours in a vacuum oven at about 50 torr.

As a result of GPC analysis, a weight-average molecular weight of the random copolymer was about 89,000 Daltons.

As a result of DSC analysis, a melting point due to the random copolymer was observed at about 50° C.

### Comparative Example 2

### Preparation of Block Copolymer [7(Homo-Block)(CL/LD=100/0):3(Block)]

About 14 g of CLN was introduced into a 250 ml glass reactor equipped with a stirrer, a heating device, a condenser, and a vacuum unit in a nitrogen atmosphere, and the temperature was then increased to about 120° C. to remove moisture while stirring at about 50 rpm. Then, about 0.5 wt % of tin(II) 2-ethylhexanoate (Sn(Oct)₂), as a catalyst, was further added and polymerized at about 150° C. for about 1 hour. Once the polymerization was complete, a caprolactone homopolymer was obtained by removing unreacted caprolactone from the polymerization product under a vacuum of about 20 torr using a vacuum pump.

About 6 g of D-lactide was added to the homopolymer, about 0.5 wt % of tin(II) 2-ethylhexanoate (Sn(Oct)₂), as a catalyst, was further added thereto, and polymerization was performed at about 150° C. for about 0.5 hours.

Once the polymerization was complete, the polymerization product was dissolved in about 120 g of chloroform and was then reprecipitated in about 600 ml of methanol. Then, a block copolymer, in which a poly-D-lactic acid homopolymer block was added to the caprolactone homopolymer block, was obtained by removing unreacted D-lactide from the precipitate by drying the precipitate at about 50° C. for about 8 hours in a vacuum oven at about 50 torr.

As a result of GPC analysis, a weight-average molecular weight of the block copolymer was about 92,000 Daltons.

As a result of DSC analysis, a first melting point due to the caprolactone homopolymer block was observed at about 60° C. and a second melting point due to the PDLA homopolymer block was observed at about 147° C.

### Comparative Example 3

### PLLA Homopolymer

A poly-L-lactic acid (PLLA, Nature Works, 4030D) homopolymer resin was obtained and used as it is.

As a result of DSC analysis, a melting point of the PLLA homopolymer was observed at about 168° C.

### Preparation of Thermoplastic Resin Composition

### Example 5

### PLLA:Block Copolymer=80:20

About 20 g of the block copolymer prepared in Example 1, about 80 g of a polylactic acid (poly-L-lactic acid, PLLA, Nature Works 4030D) homopolymer, about 1 g of talc having an average particle diameter of about 2 μm as a nucleating agent, and about 3 g of modified vegetable oil (epoxidized soybean oil, ESO, Sigma-Aldrich) as a plasticizer were dry blended. Then, an extrudate, which was obtained by performing melt compounding at a processing temperature of about 200° C. and a screw speed of about 30 rpm to about 100 rpm in a twin-screw extruder (Process 11 micro twin-screw extruder, Thermo Scientific) having a barrel diameter of about 11 mm and a barrel length/barrel diameter (L/D) ratio of about 40, was dried at about 40° C. for about 24 hours to prepared a resin composition.

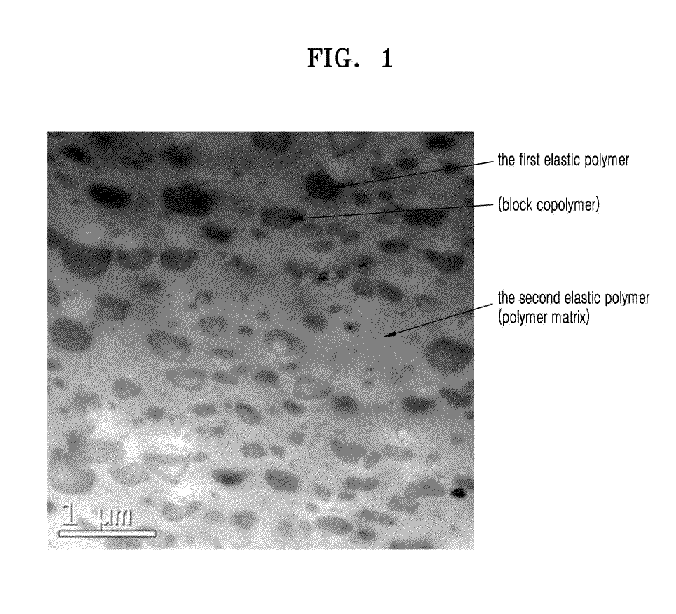

As illustrated in FIG. 1, it was observed that the thermoplastic resin composition had a structure in which block copolymers were uniformly distributed in a polylactic acid (PLLA) homopolymer matrix. Since the block copolymers absorbed external impact while being distributed in the matrix, the impact resistance was improved. Since the plasticizer was distributed at an interface between the block copolymer and the polylactic acid homopolymer matrix and reacted, the plasticizer improved the cohesion between the block copolymer and the matrix. Also, since the block copolymer and the matrix formed a stereo complex, the heat resistance was improved.

### Example 6

### PLLA:Block Copolymer=85:15

A thermoplastic resin composition was prepared in the same manner as in Example 5 except that about 15 g of the block copolymer prepared in Example 1 and about 85 g of a polylactic acid (poly-L-lactic acid, PLLA, Nature Works 4030D) homopolymer were used.

### Example 7

### PLLA:Block Copolymer=90:10

A thermoplastic resin composition was prepared in the same manner as in Example 5 except that about 10 g of the block copolymer prepared in Example 1 and about 90 g of a polylactic acid (poly-L-lactic acid, PLLA, Nature Works 4030D) homopolymer were used.

### Example 8

### PLLA:Block Copolymer=80:20

A thermoplastic resin composition was prepared in the same manner as in Example 5 except that about 20 g of the block copolymer prepared in Example 2 was used instead of about 20 g of the block copolymer prepared in Example 1.

### Example 9

### PLLA:Block Copolymer=80:20

A thermoplastic resin composition was prepared in the same manner as in Example 5 except that about 20 g of the block copolymer prepared in Example 3 was used instead of about 20 g of the block copolymer prepared in Example 1.

### Example 10

### PLLA:Block Copolymer=80:20

A thermoplastic resin composition was prepared in the same manner as in Example 5 except that about 20 g of the block copolymer prepared in Example 4 was used instead of about 20 g of the block copolymer prepared in Example 1.

### Comparative Example 4

### PLLA:Random Copolymer=80:20

A thermoplastic resin composition was prepared in the same manner as in Example 10 except that about 20 g of the random copolymer prepared in Comparative Example 1 was used instead of about 20 g of the block copolymer prepared in Example

### Comparative Example 5

### PLLA:Block Copolymer=80:20

A thermoplastic resin composition was prepared in the same manner as in Example 10 except that about 20 g of the block copolymer prepared in Comparative Example 2 was used instead of about 20 g of the block copolymer prepared in Example 1.

### Comparative Example 6

### PLLA:Block Copolymer=100:0

A thermoplastic resin composition was prepared in the same manner as in Example 10 except that about 100 g of the PLLA homopolymer of Comparative Example 3 was only used and plasticizer and talc were not added.

### Evaluation Example 1

### Impact Strength Measurement

The extrudates, as the thermoplastic resin compositions prepared in Examples 5 to 10 and Comparative Examples 4 to 6, were dried in an oven at about 50° C. for about 8 hours, and specimens (about 64 mm (length)×about 12 mm (width)×about 3 mm (depth)) for Izod test according to ASTM D256 were then prepared from the extrudates by using a molding apparatus (Haake Minijet Injection Molding System, Thermo Scientific) under conditions including a resin melt temperature of about 200° C., an injection pressure of about 750 bar, a mold temperature of about 100° C., and an injection time of about 7 minutes. Izod impact strength was measured by performing a notched Izod impact test according to the ASTM D256 test method. The results thereof are presented in Table 1 below.

### Evaluation Example 2

### Thermal Stability Measurement

Glass transition temperatures (T_{g}), crystallization temperatures (Tₐ), and melting temperatures (Tₘ) of the thermoplastic resin compositions prepared in Examples 5 to 10 and Comparative Examples 4 to 6 were measured by using a dynamic scanning calorimeter (DSC). The results thereof are presented in Table 1 below.

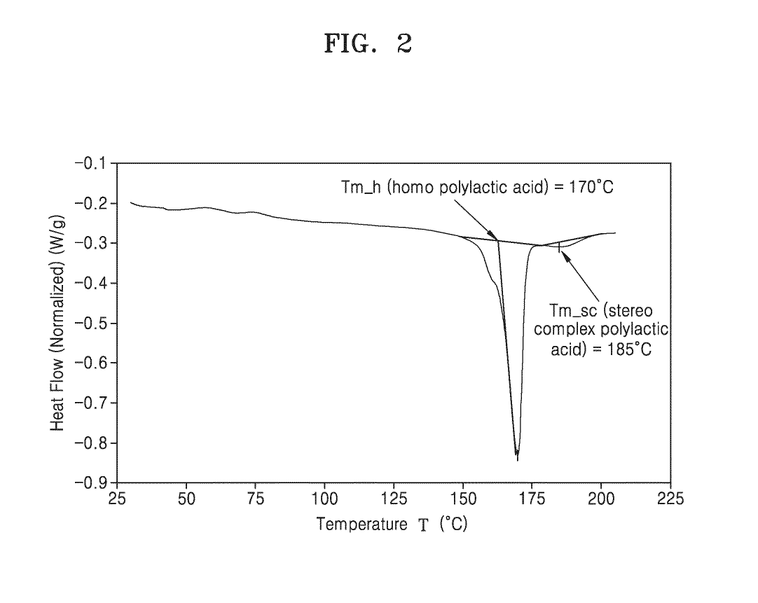

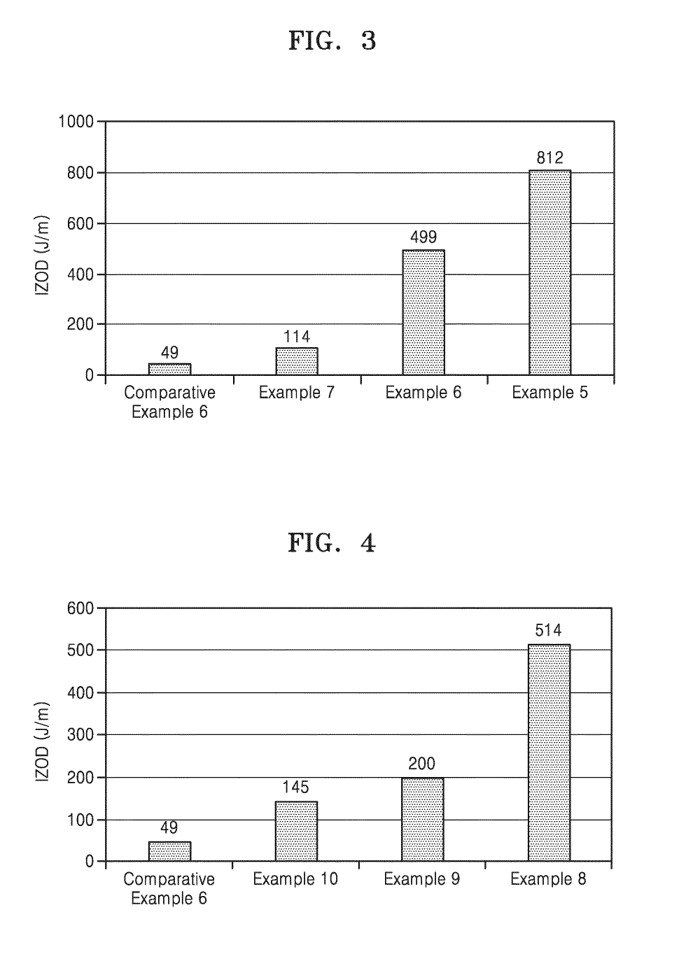

For example, as illustrated in FIG. 2, as a result of DSC analysis of the thermoplastic resin composition of Example 5, a melting point corresponding to the polylactic acid homopolymer and a melting point corresponding to the polylactic acid forming the stereo complex were respectively observed.

TABLE 1

| | I_{ZOD} impact | | | | |
|---|---|---|---|---|---|
| | strength | T_{g} | T_{c} | Tₘ_{_{—}}ₕ | Tₘ_{_{—}}_{sc} |
| | [J/m] | [° C.] | [° C.] | [° C.] | [° C.] |
| Example 5 | 812 | 42/65 | 96 | 170 | 185 |
| Example 6 | 499 | 63 | 97 | 169 | 184 |
| Example 7 | 114 | 60 | 99 | 170 | 184 |
| Example 8 | 514 | — | 94 | 169 | 198 |
| Example 9 | 200 | 62 | 93 | 169 | 196 |
| Example 10 | 145 | 60 | 94 | 170 | 198 |
| Comparative | 87 | — | 108 | 170 | — |
| Example 4 | | | | | |
| Comparative | 100 | 42 | 94 | 169 | 199 |
| Example 5 | | | | | |
| Comparative | 49 | — | — | 168 | — |
| Example 6 | | | | | |

Wherein T_{g}: glass transition temperature;
T_{c}: crystallization temperature;
Tₘ_{_{—}}ₕ: melting temperature of homo polylactic acid; and
Tₘ_{_{—}}_{sc}: melting temperature of stereo complex polylactic acid.

As illustrated in Table 1, the thermoplastic resin compositions of Examples 5 to 10 containing the block copolymer including the random copolymer block had significantly improved impact strength in comparison to the thermoplastic resin composition of Comparative Example 4 only containing the random copolymer, the thermoplastic resin composition of Comparative Example 5 containing the block copolymer that did not include a random copolymer, and the thermoplastic resin composition of Comparative Example 6 formed of the polylactic acid homopolymer. Further, the thermoplastic resin compositions of Examples 5 to 10 had good heat resistance.

As described above, according to the one or more of the above exemplary embodiments, impact resistance and heat resistance of a resin composition including a polylactic acid may be improved by including a block copolymer that includes a random copolymer block.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermoplastic resin composition comprising:
a first thermoplastic polymer; and
a second thermoplastic polymer,
wherein the first thermoplastic polymer is a block copolymer including a plurality of polymer blocks, and at least one of the plurality of polymer blocks comprises a random copolymer,
and wherein at least one structural unit of the first thermoplastic polymer is a stereoisomer of a structural unit of the second thermoplastic polymer.

2. The thermoplastic resin composition of claim 1, wherein the random copolymer comprises two or more structural units of two or more monomers selected from the group consisting of an ether-group containing monomer, an olefin-group containing monomer, a vinyl-group containing monomer, a polyol-group containing monomer, a polybasic acid-group containing monomer, an isocyanate-group containing monomer, an acrylate-group containing monomer, a vinyl alcohol-group containing monomer, an ethylene-group containing monomer, an ester-group containing monomer, a silicon-group containing monomer, and a lactone-group containing monomer.

3. The thermoplastic resin composition of claim 1, wherein the random copolymer comprises two or more structural units of two or more monomers selected from the group consisting of lactic acid, styrene, vinylnaphthalene, methyl methacrylate, caprolactone, valerolactone, butyrolactone, butadiene, isobutylene, styrene-butadiene, methylsiloxane, ethylene, propylene, 1-butene, 4-methyl-pentene, norbornenyl ethyl styrene, hexamethyl carbonate, hexyl norbornene, butyl succinate, dicyclopentadiene, cyclohexylethylene, 1,5-dioxepane-2-on, 4-vinylpyridine, isoprene, 3-hydroxybutyrate, 2-hydroxy methacrylate, N-vinyl-2-pyrrolidone, 4-acryloyl morpholine, ethylene oxide, ethylene glycol, acrylonitrile, a vegetable oil derivative, propylene glycol, tetramethylene ether glycol, para-dioxanone, propylene carbonate, tetramethyleneadipate, terephthalate, butylene adipate, and butylene succinate.

4. The thermoplastic resin composition of claim 1, wherein the random copolymer comprises a first structural unit comprising a D-lactic acid and a second structural unit other than D-lactic acid.

5. The thermoplastic resin composition of claim 4, wherein the second structural unit comprises caprolactone.

6. The thermoplastic resin composition of claim 4, wherein the random copolymer comprises about 10 wt % to about 50 wt % of the first structural unit and about 50 wt % to about 90 wt % of the second structural unit.

7. The thermoplastic resin composition of claim 1, wherein the glass transition temperature (T_{g}) of the random copolymer is lower than about 0° C.

8. The thermoplastic resin composition of claim 1, wherein a weight-average molecular weight of the random copolymer is about 30,000 Daltons to about 100,000 Daltons.

9. The thermoplastic resin composition of claim 1, wherein the block copolymer comprises a first polymer block of a random copolymer and a second polymer block of a homopolymer.

10. The thermoplastic resin composition of claim 9, wherein the homopolymer is poly-D-lactic acid.

11. The thermoplastic resin composition of claim 9, wherein the block copolymer comprises about 50 wt % to about 90 wt % of the first polymer block and about 10 wt % to about 50 wt % of the second polymer block.

12. The thermoplastic resin composition of claim 1, wherein a weight-average molecular weight of the block copolymer is about 50,000 Daltons to about 150,000 Daltons.

13. The thermoplastic resin composition of claim 1, wherein the block copolymer has a first melting point of about 30° C. to about 60° C. and a second melting point of about 110° C. to about 170° C.

14. The thermoplastic resin composition of claim 1, wherein the second thermoplastic polymer is poly-L-lactic acid.

15. The thermoplastic resin composition of claim 1, wherein the thermoplastic resin composition comprises about 5 wt % to about 30 wt % of the first thermoplastic polymer based on the total weight of the thermoplastic resin composition.

16. The thermoplastic resin composition of claim 1, wherein the thermoplastic resin composition comprises about 65 wt % to about 90 wt % of the second thermoplastic polymer based on a total weight of the thermoplastic resin composition.

17. The thermoplastic resin composition of claim 1, further comprising a plasticizer.

18. The thermoplastic resin composition of claim 17, wherein the plasticizer comprises a vegetable plasticizer.

19. The thermoplastic resin composition of claim 17, wherein the thermoplastic resin composition comprises about 5 wt % to about 30 wt % of the first thermoplastic polymer, about 65 wt % to about 90 wt % of the second thermoplastic polymer, and about 1 wt % to about 5 wt % of the plasticizer based on a total weight of the thermoplastic resin composition.

20. A molded article comprising the thermoplastic resin composition of claim 1.
